(19) United States
(12) Patent Application Publication
(10) Pub. No.: US 2005/0279265 A1
(43) Pub. Date: Dec. 22, 2005

(54) Wire-guiding structure of a shuttle of a sewing machine

(76) Inventor: Chih-I Chien, Chiai Hsien (TW)

Correspondence Address: CHIH-I CHIEN, 235 CHUNG-HO BOX 8-24, TAIPEI HSIEN, TW

(21) Appl. No.: 10/795,821

(22) Filed: Mar. 9, 2004

(51) Int. Cl. B65H 81/02; H01F 41/08; D05B 57/14

(52) U.S. Cl. 112/231

(57) ABSTRACT

A wire-guiding structure of a shuttle of a sewing machine is disclosed. One end surface of the shuttle is formed with a wire-receiving hole for supplying wire continuously. A wire for seaming is supplied to an interior of the shuttle from an external larger scale wire-winding and the wire is wound around the wire-winding wheel for outputting. It is unnecessary to update the shuttle so as to increase the finishing efficiency. Furthermore, the end surface of the shuttle is installed with a wire-guiding rod for guiding wire successfully so that the wire can run along a predetermined path efficiently. Thus wire can be supplied successfully. Moreover, a wire-winding wheel is installed in the shuttle so that wire will be easily wound around the wire-winding wheel smoothly. Thus wire is supplied to the sewing machine successfully.

### FIELD OF THE INVENTION

The present invention relates to wire-windings of shuttles, and particular to a wire-guiding structure of a shuttle of a sewing machine so that the wire is supplied to the shuttle continuously by using a wire-guiding rod.

### BACKGROUND OF THE INVENTION

Shuttles of sewing machines are wire collectors for supplying seaming wires. The shuttles are pivotally installed to rotary seats on needle guiding paths of sewing machines. In seaming, the wired needles will hook wires on the shuttles as the needles are inserted into cloths.

The prior art shuttle has a casing and a wire-winding wheel pivotally installed within the casing. Before use, wire is wound around the wire-winding wheel and then the wire-winding wheel is placed in the casing. The shuttle is then placed on the rotary seat in the needle guiding path of sewing machine for assuring that the wire can be normally supplied. However, amount of wire capable being collected in the wire-winding wheel in the casing is limited. Each wire-winding wheel only has finite wire capable of being supplied to the seaming process. Thereby, in the seaming process, the user must take out the shuttle for winding new wire. However, this will reduce the winding efficiency. Thus the shuttle must be updated or rewound frequently. This is a tedious work to the users.

Above mentioned defect especially occurs at a large scale sewing machine with a great amount of shuttles. If the wire is used up, the machine must be stopped for detaching the shuttle and updating new ones with sufficient wires. Then the sewing machine is restarted. Thereby, much labor is required, efficiency is low and cost is increased.

### SUMMARY OF THE INVENTION

Accordingly, the primary object of the present invention is to provide a wire-guiding structure of a shuttle of a sewing machine, wherein wire supplied to the shuttle is increased greatly and the wire can be successfully supplied to the sewing machine by using a wire-guiding rod.

To achieve above objects, the present invention provides wire-guiding structure of a shuttle of a sewing machine, wherein one end surface of the shuttle is formed with a wire-receiving hole for supplying wire continuously. Wire for seaming is supplied to the interior of the shuttle from an external larger scale wire-winding and the wire is wound around the wire-winding wheel for outputting. It is unnecessary to update the shuttle so as to increase the finishing efficiency. Furthermore, the end surface of the shuttle is installed with a wire-guiding rod for guiding wire successfully so that the wire can run along a predetermined path efficiently. Thus wire can be supplied successfully. Moreover, a wire-winding wheel is installed in the shuttle so that wire will be easily wound around the wire-winding wheel smoothly. Thus wire is supplied to the sewing machine successfully.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is an exploded perspective view of the present invention.

FIG. 3 is a schematic view showing that the engaging sheet is slidably installed in the casing according to the present invention.

FIG. 3a is a schematic view along line a-a of FIG. 3.

FIG. 4 is a schematic view showing the guiding of the wire according to the present invention.

FIG. 4a is a schematic view along line b-b of FIG. 4.

FIG. 5 is a lateral schematic view showing the guiding of wire of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

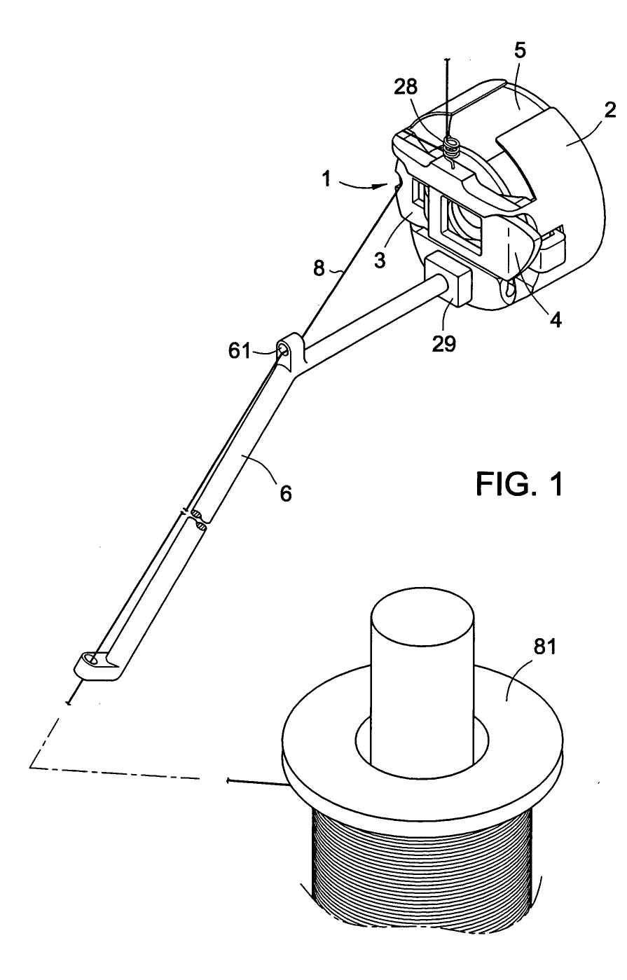

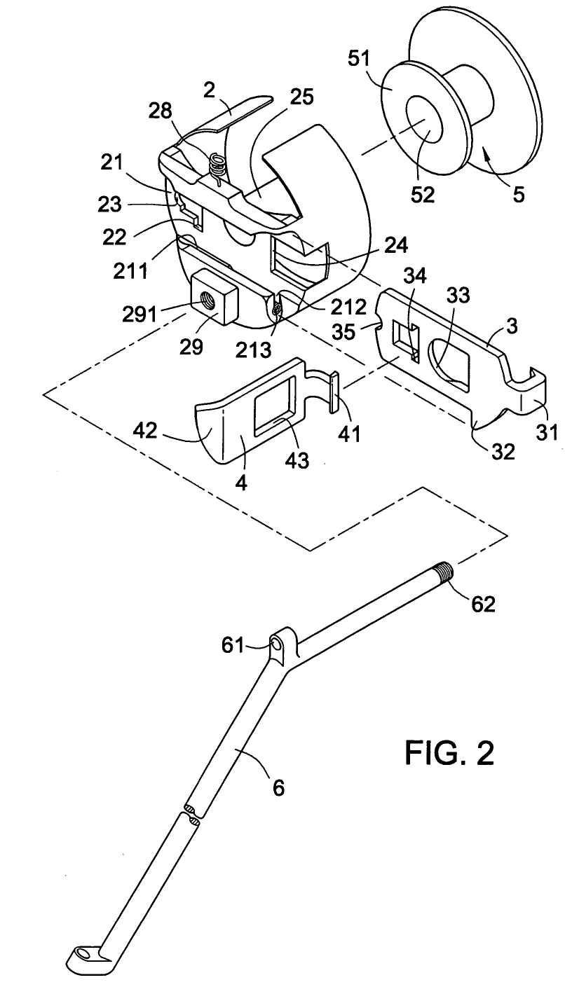

With reference to FIG. 2, an exploded perspective view of the wire-guiding structure of a shuttle of a sewing machine according to the present invention is illustrated. The wire-guiding structure includes a casing 2, an engaging sheet 3 which is combined with the casing 2 so as to form a wire-receiving hole 11; a buckle 4 for buckling the engaging sheet 3 to the casing 2, a wire-winding wheel 5 for winding a wire 8 successfully, and a wire-guiding rod 6 for guiding the wire 8 (referring to FIG. 1). By above mentioned structure, the wire is supplied through a shuttle successfully. The wire is outputted from a larger wire-winding 81.

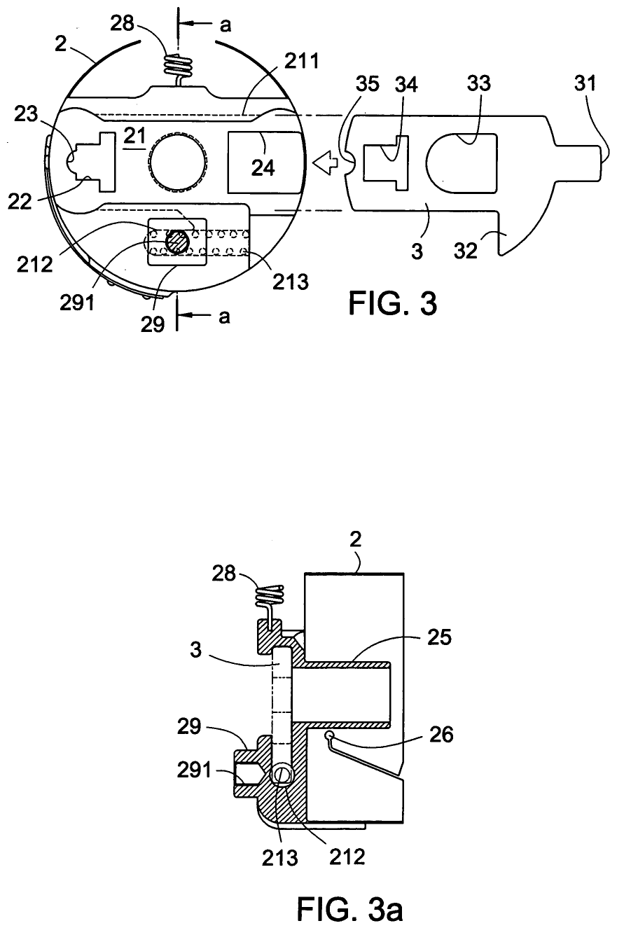

An end surface of the casing 2 is installed with a sliding channel 21 for receiving the engaging sheet 3 (referring to FIGS. 3 and 3a). Each of two sides of the sliding channel 21 is installed with a receiving groove 212. Each receiving groove 212 is installed with a spring 213. An end surface of the sliding channel 21 is installed with a T shape buckling slot 22. One end of the buckling slot 22 is formed with a semi-round wire-guiding slot 23. The buckling slot 22 corresponding the sliding channel 21 is installed with an opening 24. An end surface of the casing 2 is inwards protruded with a hollow pivotal shaft 25. Another end of the casing 2 is installed with a wire outlet slit 26. A press 27 is assembled to the wire outlet slit 26. Furthermore, one side of the casing 2 is extended with a wire-guiding ring 28. An end surface of the casing 2 is protruded with a protrusion 29. A lock hole 291 is formed on the protrusion 29.

One end of the engaging sheet 3 is bent to be as a press 31 (referring to FIG. 2). One side of the engaging sheet 3 adjacent to the press 31 is a stopper 32. The engaging sheet 3 is slidably installed to the opening 24 of the sliding channel 21. The stopper 32 is slidably installed in the receiving groove 212 of the sliding channel 21 and resists against the spring 213. One end of the engaging sheet 3 is installed with another semi-round wire-guiding slot 35. The wire-guiding slot 35 is combined with the wire-guiding slot 23 of the casing 2 to form a wire-receiving hole 11. Another T shape buckling hole 34 is installed on the engaging sheet 3. The engaging sheet 3 is formed with an embedding hole 33 adjacent to the buckling hole 34.

One end of the buckle 4 is extended with a buckling portion 41. The buckling portion 41 passes through buckling hole 34 of the engaging sheet 3 and the buckling slot 22 of the casing 2. The engaging sheet 3 is buckled to the sliding channel 21 of the casing 2. Another end of the buckle 4 is bent to form with a slightly cured movable portion 42. The buckle 4 is formed with a rectangular opening 43.

The wire-guiding rod 6 is bent with an apex, see FIG. 2. One end of the wire-guiding rod 6 has outer threads 62. The wire-receiving slot 23 is locked to the lock hole 291 in the protrusion 29 of the casing 2 (referring to FIG. 1), and another end thereof is adjacent to the larger wire-winding 81 which is further adjacent to the seat frame of a sewing machine, see FIG. 1. At least one wire-guiding ring 61 extends from the wire-guiding rod 6. The wire-guiding rod 6 may be an elastic rod. The wire-guiding rod 6 can be placed at any end portion of the casing 2 so that the at least one wire-guiding ring 61 may be formed with a path between the wire-receiving hole 11 and the large wire-winding 81.

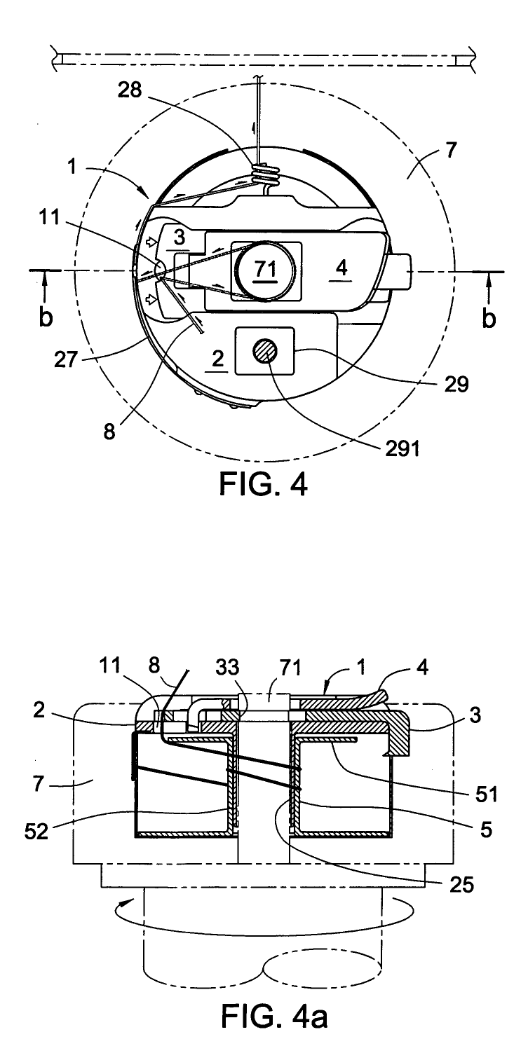

Two sides of the wire-winding wheel 5 are formed with two disks at two ends. The sizes of the two disks are unequal (referring to FIG. 2). A center of the wire-winding wheel 5 is formed with a hollow axial hole 52. The wire-winding wheel 5 is pivotally installed to the pivotal shaft 25 of the casing 2 by the axial hole 52 (referring to FIG. 4a).

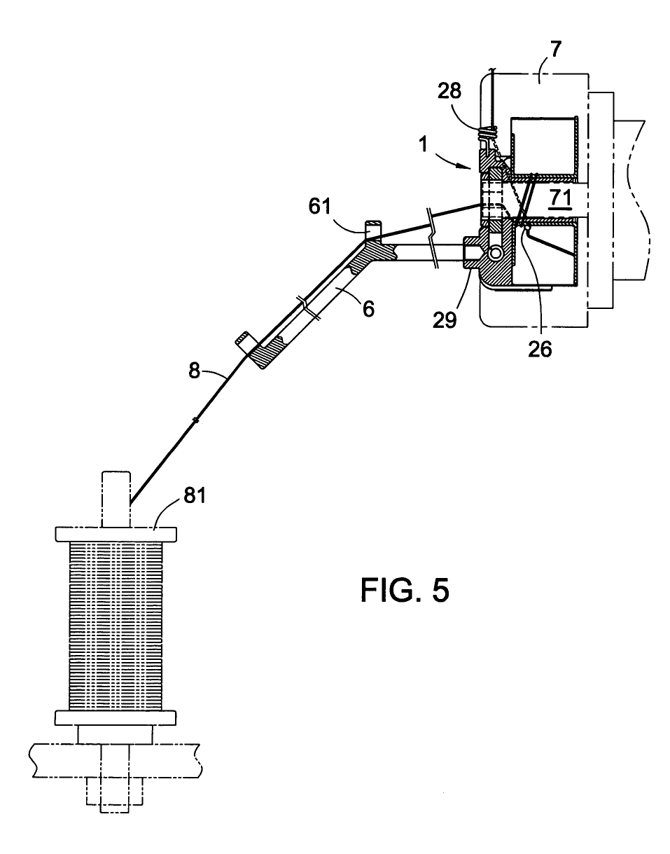

By above components, before seaming, the casing 2, engaging sheet 3 and buckle 4 are assembled, see FIG. 4 so that the end surface of the shuttle is formed with a wire-receiving hole 11 for receiving the wire 80. Then the pivotal shaft 25 of the casing 2 is pivotally installed to the wire-winding wheel 5 (referring to FIG. 4a). Then, wire 8 is taken out from the large wire-winding installed at the seat frame at a lower end of the sewing machine (referring to FIG. 5). Then the wire is inserted into the at least wire-guiding ring 61 on the wire-guiding rod 6 so that the wire can be guided to the shuttle 1 continuously and then is wound around the wire-winding wheel 5 successfully for seaming. Thereby, the wire supply of the shuttle 1 is greatly increased.

Since the wire on the large wire-winding 8 is sufficient, the wire supply is greatly increased than those supplied from conventional way in that only the shuttle is used for supplying wires. Thereby, the times for updating wires are reduced greatly. This effect is more apparent for the large sewing machine with a plurality of shuttles.

In the process of supplying the wire 8 from the large wire-winding 81, see FIG. 5, the wire 8 is guided by the wire-guiding ring 61 on the wire-guiding rod 6. Thereby, the wire 8 proceeds along a predetermined path formed by the wire-guiding rod 6 and thus the wire of the shuttle 1 is smoothly supplied.

Furthermore, since the wire-receiving hole 11 is arranged on an outer edge of a disk 51 having a smaller size (referring to FIGS. 4 and 4a). Therefore, the wire 8 enters into the wire-winding wheel 5 from the wire-receiving hole 11 so as not to be stopped by the disk 51 of the wire-winding wheel 5. Thus, the wire body 8 is successfully wound around the wire-winding wheel 5 and as a result the wire is smoothly supplied from the shuttle 1.

Further, the wire 8 outputted from the wire-winding wheel 5 (referring to FIGS. 4 and 4a) enters into the wire-winding wheel 5 axially from the wire-receiving hole 11. Then the wire is radially outputted from the wire-winding wheel 5 to the seaming portion of the sewing machine. Thus, output speed of the wire 8 is smooth so as to retain a predetermined tension on the wire-winding wheel 5. Thereby, the wire 8 will not wind irregularly because the wire is loose. Thus the wire can be successfully supplied from the shuttle 1.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A wire-guiding structure of a shuttle of a sewing machine comprising:
a casing; one end surface of the casing having a sliding channel; one end surface of the sliding channel being formed with a T shape buckling slot; the T shape buckling slot of the casing having a semi-round wire-guiding slot;
an engaging sheet slidably installed on the sliding channel of the casing; and the engaging sheet having a T shape buckling hole; one end of the engaging sheet being installed with a semi-round wire-guiding slot; the wire-guiding slot of the engaging sheet and the wire-guiding slot of the casing being formed as a wire-receiving hole;
a buckle; a buckling portion extending from the buckle; the buckling portion inserting into the buckling hole of the engaging sheet and the buckling slot of the casing so that the engaging sheet is buckled to the sliding channel of the casing;
a wire-winding wheel pivotally in the casing; two sides of the wire-winding wheel having a larger round disk and a small round disk; the wire-receiving hole being adjacent to the small round disk;
a wire-guiding rod fixed to the end surface of the casing; the wire-guiding rod having at least one wire-guiding ring which forms a path between an external wire supplying unit and the wire-receiving hole.

2. The wire-guiding structure of a shuttle of a sewing machine as claimed in claim 1, wherein the end surface of the casing has a protrusion, the protrusion has a lock hole for locking the wire-guiding rod.

3. The wire-guiding structure of a shuttle of a sewing machine as claimed in claim 2, wherein a locking end of the wire-guiding rod has outer threads.

4. The wire-guiding structure of a shuttle of a sewing machine as claimed in claim 1, wherein the wire-guiding rod is elastic.

5. The wire-guiding structure of a shuttle of a sewing machine as claimed in claim 1, wherein the wire-guiding rod is bent to have a tip end.

6. The wire-guiding structure of a shuttle of a sewing machine as claimed in claim 1, wherein the external wire supplying unit is a larger wire-winding disposed near a leg seat at a lower end of a sewing machine.
